(19) United States
(12) Patent Application Publication
(10) Pub. No.: US 2012/0159822 A1
(43) Pub. Date: Jun. 28, 2012

(54) BORDER TRIM ASSEMBLY AND METHOD OF USE FOR WOOD-FRAMED BILLBOARD WITH CABLE TENSIONING SYSTEM

(75) Inventors: John Dove Gibb, Buford, GA (US); Thomas Stover, Braselton, GA (US)

(73) Assignee: Formetco, Inc., Duluth, GA (US)

(21) Appl. No.: 12/978,163

(22) Filed: Dec. 23, 2010

(51) Int. Cl. G09F 15/00

(52) U.S. Cl. 40/606.01

(57) ABSTRACT

A border trim assembly for a billboard frame having a gap between the frame and a display sheet, the assembly comprising: a base member having a front face, and a hanger section configured to affix to the billboard frame; a concave member positioned on said hanger section; a trim cap having a support extension and a contact extension configured to rotate about said concave member, wherein said trim cap is configured to cover the gap; and a spring positioned between said hanger section and said support extension wherein said spring is configured to rotate said trim cap about said concave member.

### TECHNICAL FIELD

The disclosure relates generally to border trim on a billboard and more specifically it relates to border trim for wood-framed billboards or similar flat surfaces.

### BACKGROUND

Printed words, photographs, or drawings on flexible semi-translucent media, such as vinyl, polyethylene, or polypropylene sheets attached to or stretched over a metal or wooden substrate forming an advertising billboard or commercial signage, have been in use for many years and are known in the prior art. The sheets are typically attached to the substrate by an apparatus attached either to the back or the front of the substrate. When a frontal attachment method is used, decorative trim is typically placed around the perimeter of the substrate and mounted several inches from the face of the substrate to conceal the attachment apparatus. The trim creates the appearance of a picture frame. Unlike a picture frame, however, there is a gap of several inches between the trim and the advertising display sheet. When the billboard is mounted high in the air above motorists or pedestrians, the gap is not generally noticeable. But when the billboard is located closer to the ground, the gap is noticeable and can be an undesirable distraction from the advertising display.

Another problem resulting from the gap between the border trim or frame and the substrate is the accumulation of debris that can occur along the bottom portion of the billboard. On billboards mounted close to the ground, which is a prevalent practice in European and other countries outside North America, drinking cups, bottles, and other trash is often thrown or placed in the gap, which can interfere with the operation of the apparatus when the display sheet is changed. The trash can also pile up blocking vision of a part of the display face and create a potential for injury to a worker removing broken bottles and other hazardous trash placed in the gap.

A recent frontal attachment apparatus and method is the cable tensioning system disclosed in U.S. Patent Application No. 20090019750 filed Jul. 16, 2007, comprised of cables, anchor plates, cable guides, locking clips, and a spring-loaded tension device, which application is incorporated herein by this reference in its entirety. Typically, the cable tensioning system is concealed by a wood frame around the perimeter of the billboard, which forms the border trim.

Therefore, it is readily apparent that there is a recognizable unmet need for a border trim assembly and method of use for a wood-framed billboard with a cable tensioning system, wherein a border trim apparatus may be configured to fit one or more sizes and configurations of a billboard to conceal the media sheet rigging and tensioning system and cover the gap between the frame and the display sheet.

### BRIEF SUMMARY

Briefly described, in example embodiment, the present apparatus overcomes the above-mentioned disadvantages and meets the recognized need for a border trim assembly and method of use for a wood-framed billboard with cable tensioning system comprising, in general, a trim base having a front face and a hanger section configured to affix to the billboard frame; a concave member positioned on the hanger section; a trim cap having a support extension and a contact extension configured to rotate about the concave member, wherein the trim cap is configured to cover the gap; and a spring positioned between one of the hanger sections and the support extension wherein the spring is configured to rotate the trim cap about the concave member and, thus, functions to conceals from pubic view the cable, pulleys, guides, and other individual components of a typical billboard cable tensioning system used to secure and stretch a printed display sheet and which further protects the components from weather, dust, and undesirable debris.

According to its major aspects and broadly stated, the present apparatus meets the recognized need for a border trim assembly comprising, in general, a base member having a front face, and a hanger section configured to affix to the billboard frame, a concave member positioned on the hanger section, and a trim cap having a support extension and a contact extension configured to rotate about the concave member, wherein the trim cap is configured to cover the gap.

In a further exemplary embodiment of a border trim assembly for a billboard frame having a gap between the frame and the display sheet, the assembly includes a base member having a front face and a hanger section configured to affix to the billboard frame; a concave member positioned on the hanger section; a trim cap having a support extension and a contact extension configured to rotate about the concave member wherein the trim cap is configured to cover the gap; and a leaf spring positioned between the hanger section and the support extension wherein the leaf spring is configured to rotate the trim cap about the concave member.

In still a further exemplary embodiment, the method of filling a gap between a billboard frame and a display sheet includes the steps of providing a border trim assembly, which further comprises a base member having a front face and a hanger section configured to affix to the billboard frame; a concave member positioned on the hanger section; a trim cap having a support extension and a contact extension configured to rotate about the concave member wherein the trim cap is configured to cover the gap; mounting the trim assembly to the billboard frame; adjusting the trim assembly to fit the gap between the display sheet and the billboard frame; and positioning a leaf spring between the hanger section and the support extension wherein the leaf spring is configured to rotate the trim cap about the concave member to cover the gap.

Accordingly, a feature of the trim assembly is its ability to provide a trim base that can accommodate various sizes and dimensions of wood framed billboards.

Another feature of the trim assembly is its ability to provide a hinge configuration between the trim base and trim cap that is easy to assemble.

Still another feature of the trim assembly is its ability to provide a trim base and trim cap configured to withstand the weather and not deteriorate over time in the manner that would occur with unprotected wood trimmed or framed billboards.

Yet another feature of the trim assembly is its ability to provide a trim cap that can accommodate various sizes and dimensions of gaps between the display sheet and the wood frame of a billboard.

These and other features of the trim assembly will become more apparent to one skilled in the art from the following Brief Description of the Drawings, Detailed Drawings, and Claims when read in light of the accompanying drawings.

### BRIEF DESCRIPTION OF THE DRAWINGS

The present trim assembly and method of use for wood-framed billboards with a cable tensioning system will be better understood by reading the Detailed Description of the embodiments with reference to the accompanying drawings, in which like reference to numerals denote similar structures and refer to like elements throughout, and in which:

FIG. 1 is a perspective view of an example embodiment of a corner portion of the trim assembly in the closed position;

FIG. 2 is a side view of an example embodiment of the trim assembly in the open position;

FIG. 3 is a side view of an example embodiment of the trim assembly in the closed position;

FIG. 4 is a side view of an example embodiment of the trim assembly with a bracket attached to the T-track and shown in the open position;

FIG. 5 is a side view and frontal view of an example embodiment of a bracket;

FIG. 6 is a side view of an example embodiment of the trim assembly with a bracket attached to the T-track and shown in the closed position;

FIG. 7 is a side view of an example embodiment of the trim assembly attached to a wooden billboard frame and depicts a display sheet attached to two components of a cable tensioning system;

FIG. 8 is a side view of an example embodiment of the trim assembly with an extended hanger top, splice track, and alternative hinge configuration with the trim cap shown in the closed position as a cross-sectional side view;

FIG. 9 is a side view of an example embodiment of the trim assembly in the closed position with an alternative trim cap lock and an alternative hinge configuration.

FIG. 10A-10G is a side view of exemplary embodiments of different hinged trim caps that may be affixed to the trim base to form the trim assembly; and

FIG. 11 is a flow diagram of a method of securing a trim assembly to the billboard frame.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

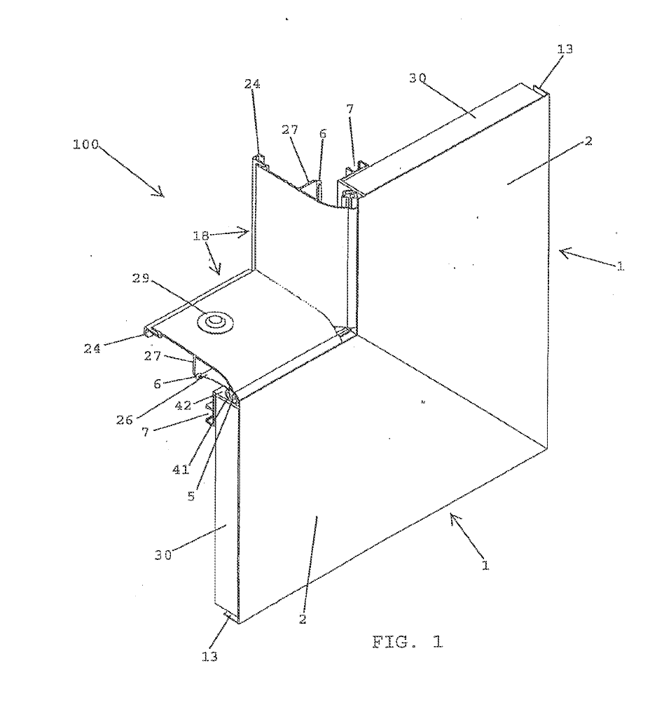

In describing the exemplary embodiments of the present disclosure, as illustrated in FIGS. 1-11 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1, by way of example, and not limitation, there is illustrated an example embodiment of trim assembly 100. Preferably, trim assembly 100 comprises the billboard frame trim cover such as trim base 1 and billboard frame and display sheet gap cover such as trim cap 18. Trim base 1 is preferably used to cover one or more sizes and configurations of billboard frames 30 and utilized to support moveable trim cap 18 and to prevent unwanted lateral or vertical motion of trim cap 18. Trim cap 18 is preferably used to fill the gap between one or more sizes and configurations of billboard frames 30 and the display sheet being displayed on such billboard.

Trim assembly 100 includes trim base 1, which preferably is cut a 45° angle at each corner when used on either a square or rectangular billboard, with front face 2 providing an attractive and protective cover over billboard frame 30. Mounting flange 13 preferably provides a surface to secure the bottom of trim base 1 to billboard frame 30 with screws or other mechanical fasteners.

Trim cap 18 preferably extends from one end at a pivot member such as hinge pin 5 to contact end 24. Trim cap 18 is preferably depicted with cap lock 29 on latitudinal trim cap 18.

It is contemplated herein that the billboard or other frame described herein may have a variety of sizes and shapes such as, but not limited to, rectangular, square, triangular, or other polyhedral or irregular shapes. In addition to billboards, trim assembly 100 may be used on signs, generally considered to be smaller in size than billboards.

Trim base 1 and trim cap 18 are preferably formed of a suitable material, such as aluminum, steel, iron, rigid plastic or plastic with metal inserts for strength, fiber, metal alloy, stainless steel, or the like, capable of providing structure to trim assembly 100. Moreover, such material may be painted, powder coated, anodized, finished with different coatings known in the industry, or installed with no finish relying upon the natural color of the material utilized. Preferably, the material includes other suitable characteristics, such as durability, rust-resistance, light weight, heat-resistance, chemical inertness, oxidation resistance, ease of workability, or other beneficial characteristics understood by one skilled in the art.

It is contemplated herein that trim base 1 and trim cap 18 may be configured and sized to accommodate various sizes of billboard frames 30 and the display sheet being displayed on such billboard.

Moreover, trim assembly 100 preferably is re-useable, in that trim assembly 100 may be repeatedly affixed to any one of one or more sizes, styles, and configurations of billboards.

Referring now to FIG. 2, there is illustrated a side view of an example embodiment of trim assembly 100 shown in the open position. Specifically, trim base 1 preferably includes extruded, stamped, shaped, bent or formed sections including front face 2, hanger or encasing sections such as mounting flange 13, hanger top 41, hanger back 42, and a guide such as flange 8, and may additionally include groove 34, and T-track 7. Preferably, front face 2 extends in a first common plane CP1 and mounting flange 13 and hanger top 41 extend in a second common plane CP2. Moreover, first common plane CP1 and second common plane CP2 preferably run perpendicular or approximately perpendicular to each other. Preferably, front face 2, mounting flange 13, hanger top 41, hanger back 42, and flange 8 are preferably configured to have dimensions to encase, cover and affix to the frame of the billboard.

It is contemplated herein that front face 2 and mounting flange 13, hanger top 41, and hanger back 42 of trim base 1 may be configured to be adjustable to fit one or more billboard frame sizes.

A first end of front face 2, trim base 1 preferably includes mounting flange 13, which preferably includes an aperture or slot such as groove 34 to facilitate drilling holes for the insertion of an attachment mechanism such as screw 15 utilized to secure trim base 1 to the billboard frame 30 (shown in FIG. 4). In addition, at a second end of front face 2, trim base 1 preferably includes right angle hanger sections such as hanger top 41, which further includes hanger sections such as hanger back 42, which still further includes T-track 7 and terminates at flange 8, which is angled from first common plane CP1, all configured to match the size and dimensions the frame (shown in FIG. 4) of the billboard and formed as a hanger to position on or encase the billboard frame 30. Still further, the intersection of front face 2 and hanger top 41 preferably includes a bumper such as base stop break 49. Base stop break 49 preferably prevents trim cap 18 from opening beyond approximately ninety (90) degrees to second common plane CP2 or beyond such other desired angle. The top surface of base stop break 49 terminates with concave trough surface member such as hinge 22, in which hinge pin 5 rotates when trim cap 18 is pivoted.

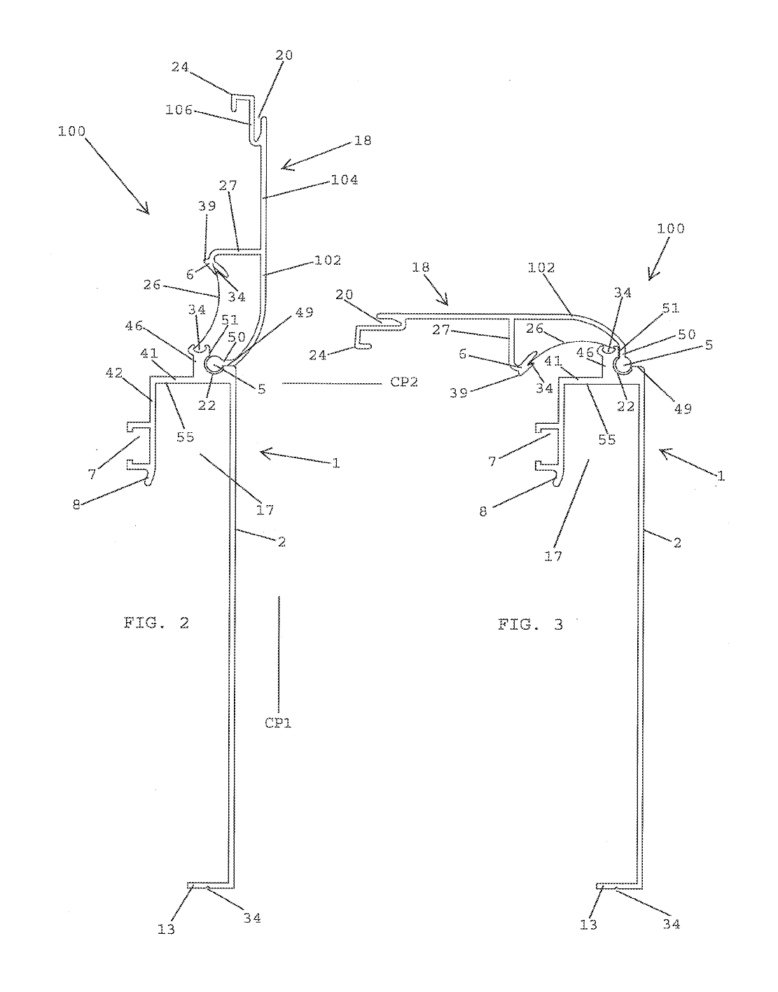

Mount leg 46 preferably extends from hanger top 41 at approximately a ninety degree (90°) angle to CP2 and preferably further includes a grooved receptacle for a spring such as leaf spring 26 and a circular surface pivot forming hinge 22, which partially surrounds hinge pin 5. Groove 34 in mount leg 46 is preferably configured to releasably retain one end of a spring such as leaf spring 26 in a compressed state. Hinge 22 of trim base 1 is preferably configured to partially encompass hinge pin 5 to enable trim cap 18 to be in rotational pivot about trim base 1. Hinge 22 is preferably C-shaped and runs the approximate length of trim base 1. Mount leg 46 preferably enables hinge pin 5 to rotate within hinge 22, specifically clockwise to the open position as shown in FIG. 2 and counter-clockwise to the closed position as shown in FIG. 3, whereby trim cap 18 rotates about trim base 1.

It is contemplated herein that leaf spring 26 may be configured from any biasing or spring element known to one of ordinary skill in the art.

The orientation of trim base 1 is reversed from top to bottom to comprise the top latitudinal trim segment or border, front face 2, and turned approximately ninety degrees) (90°) in each direction to comprise the two longitudinal trim segments or borders of a billboard, hanger top 41 and mounting flange 13. Front face 2 preferably faces a viewer of the billboard.

It is recognized that trim base 1 may be configured as one or may be pieced together and formed from separate components and may be configured in other sizes and shapes to form a recess that accommodates the size and dimensions of the wood frame of billboard.

Referring again to FIG. 2, the gap cover or extension member such as trim cap 18 preferably includes extruded, stamped, shaped, bent or formed sections including extension, contact and support extensions such as hinge pin extension 102, support extension 104, leaf mount extension 27, contact extension 106, and additionally may include opening lip 20. Preferably, hinge pin extension 102 and support extension 104 extend in a first common plane CP1, and leaf extension 27 extends in a second common plane CP2. At a first end, hinge support extension 102, preferably includes stop leg 50, which further includes a rotational pin and rib pivot member such as hinge pin 5 capable of being contained in part within hinge 22 thereby releasably retaining trim cap 18 in rotational pivot about trim base 1. Hinge pin 5 is preferably a circular solid bead or rib that runs the approximate length of trim cap 18. In addition, at a second end, hinge pin extension 102, preferably includes leaf mount extension 27, which further includes a mount such as leaf spring mount 6 configured to releasably retain the other end of a spring such as leaf spring 26 in a compressed state. Together, leaf mount 6 of trim cap 18 and groove 34 on mount leg 46 of trim base 1 are preferably configured each to hold an end of leaf spring 26 in a compressed state. Leaf spring 26 preferably biases trim cap 18 in the closed position shown in FIG. 3. Preferably, hinge pin extension 102 and support extension 104, and contact extension 106 may be configured to any desired length and configured as adjoining sections.

It is recognized herein that leaf spring 26 may be positioned between hanger top 41 and hinge pin extension 102.

Referring again to FIG. 2, at a first end, hinge pin 5 connects to stop leg 50, which connects to hinge pin extension 102 and preferably connects, at a first end, to support extension 104, which connects to contact extension 106 at a second end of support extension 104. Support extension 104 preferably includes a bifurcated end having a handle formed from opening lip 20 and display sheet contact end such as contact end 24. Moreover, contact end 24 is preferably curved or angled to provide a smooth surface to be in contact with the display sheet of the billboard. Opening lip 20 is preferably utilized to grip support extension 104 to manually disengage contact extension 106 and contact end 24 from being in contact with the display sheet. Preferably, pivotable rotation of hinge pin 5 in hinge 22 causes hinge pin extension 102 and support extension 104 to rotate about hinge 22. Hinge 22 is preferably configured to releasably retain hinge pin 5 of trim cap 18 to enable the trim cap to be in rotational pivot about trim base 1.

It is contemplated herein that trim cap 18 may be configured as one unit or may be pieced together and formed from separate components and may be configured in various sizes and shapes to form a gap cover that accommodates the gap between the display sheet and the wood frame of the billboard.

One advantage of the hinge configuration depicted in FIG. 2 is the ease in which trim cap 18 is preferably attached to trim base 1. To install, hinge pin 5 is preferably laterally inserted into hinge 22 of trim base unit 1 (as illustrated in FIG. 2), with trim cap 18 preferably in the open position. One end of leaf spring 26 is preferably inserted into groove 34 of mount leg 46 of base trim unit 1 and the other end of leaf spring 26 is preferably inserted into leaf spring mount 6 of trim cap 18. It is contemplated herein that leaf spring 26 may be a single unit or one or more units positioned at one or more appropriate intervals, specifically at approximately 24 inches to 36 inches, which creates sufficient tension to secure trim cap 18 in position relative to trim base 1 (relative to first common plane CP1). Moreover, hinge 22 is preferably configured to releasably retain hinge pin 5 of trim cap 18 to enable trim cap 18 to be in rotational pivot about trim base 1.

It is contemplated herein that hinge pin 5 and hinge 22 may extend approximately the full length or comprise partial length sections along trim cap 18 and trim base 1, respectively.

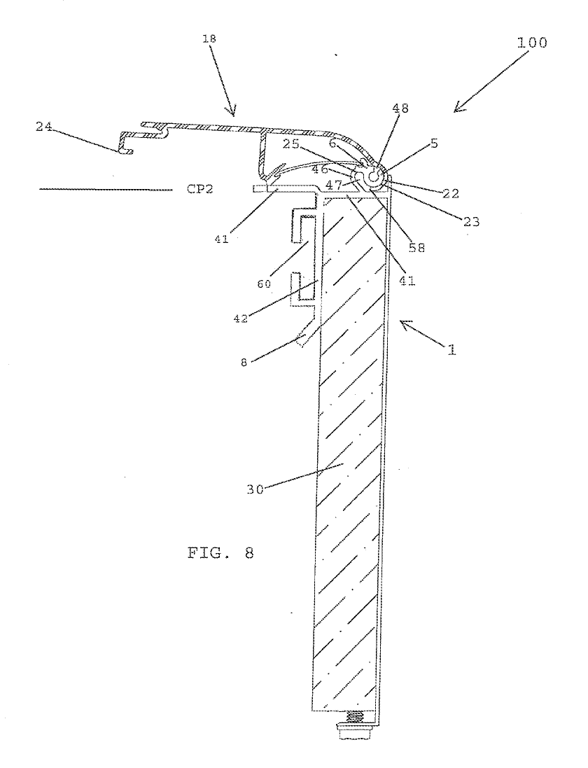

It is further contemplated herein that hinge pin 5 and hinge 22 may be reversed so as if hinge pin 5 were formed on trim base 1 and hinge 22 were formed on trim cap 18, respectively as shown in FIGS. 8 and 9. It is still further contemplated herein that hinge pin 5 and hinge 22 may be configured from any rotational or pivoting apparatus known to one of ordinary skill in the art.

Referring now to FIG. 3, there is illustrated a side view of an example embodiment of trim assembly 100 shown in the closed position. Preferably, in the closed position, stop leg 50 of trim cap 18 rests against base stop break 51 on mount leg 46 to prevent trim cap 18 from closing further than approximately ninety degrees (90°) from first common plane CP1 or such other desirable angle determined by the curve in hinge pin extension 102 and the relative positions of stop leg 50 and base stop break 51 on mount leg 46.

Referring now to FIG. 4, there is illustrated trim assembly 100 in the open position with T-track 7 securing the head of bolt 10. T-track 7 is preferably positioned approximate to hanger back 42 of trim base 1 and is sized to allow an attachment device such as square-headed or hex-headed bolt 10 to slide within T-track 7, whereby T-track 7 is configured to capture square-headed or hex-headed bolt 10 to prevent bolt 10 from rotating when nut 12 is screwed onto the threads of bolt 10. Moreover, T-track 7 is preferably configured to accommodate bolt 10, washer 11, and nut 12 to secure latch mechanism such as L-shaped bracket 16 to T-track 7 and hanger back 42 of trim base 1.

In use, trim base 1 is preferably hung onto the trim or wood frame 30 of the billboard by placing flange 8 against back surface 44 of wood frame 30 with front face 2 of trim base 1 angled (relative to first common plane CP1) away from front surface 43 of wood frame 30. Preferably, mounting flange 13 extends a sufficient distance below bottom surface 55 of wood frame 30 for clearance when trim base 1 is lowered onto top surface 45 of the wood frame 30 and the angle (relative to first common plane CP1) between front face 2 and front surface 43 of wood frame 30 is closed and front face 2 is flush with front surface 43. To secure trim base 1 to wood frame 30 a hole is drilled in bottom surface 55 of wood frame 30 through groove 34 in mounting flange 13, whereby attachment device such as screw 15 is preferably inserted to secure trim base 1 to wood frame 30.

Stop leg 50 is preferably configured to act as a stop to prevent trim cap 18 from opening beyond a desired angle, which is typically approximately ninety degrees) (90°) relative to second common plane CP2 and closing beyond a desired angle, which is approximately one hundred eighty degrees (180° relative to second common plane CP2), whereby stop leg 50 will come into contact with base stop break 51 and base stop break 49, respectively.

Again, one end of leaf spring 26 is preferably inserted into groove 34 of mount leg 46 of base trim 1 and the other end of leaf spring 26 is preferably inserted into leaf spring mount 6 of trim cap 18. It is contemplated herein that leaf spring 26 may be a single or one or more units positioned at one or more appropriate intervals, specifically at approximately 24 inches to 36 inches, which creates sufficient tension to secure trim cap 18 in the open position relative to trim base 1 (relative to first common plane CP1). Moreover, hinge 22 is preferably configured to releasably retain hinge pin 5 of trim cap 18 to enable trim cap 18 to be in rotational pivot about trim base 1, wherein such rotational pivot is a result of tension created by leaf spring 26.

It is contemplated herein that hinge pin 5 is preferably a circular solid bead or rib that runs the approximate length of trim cap 18 and, together with stop leg 50, hinge pin extension 102, support extension 104, and contact extension 106 together may extend approximately the full length of trim base 1 (shown in FIG. 1).

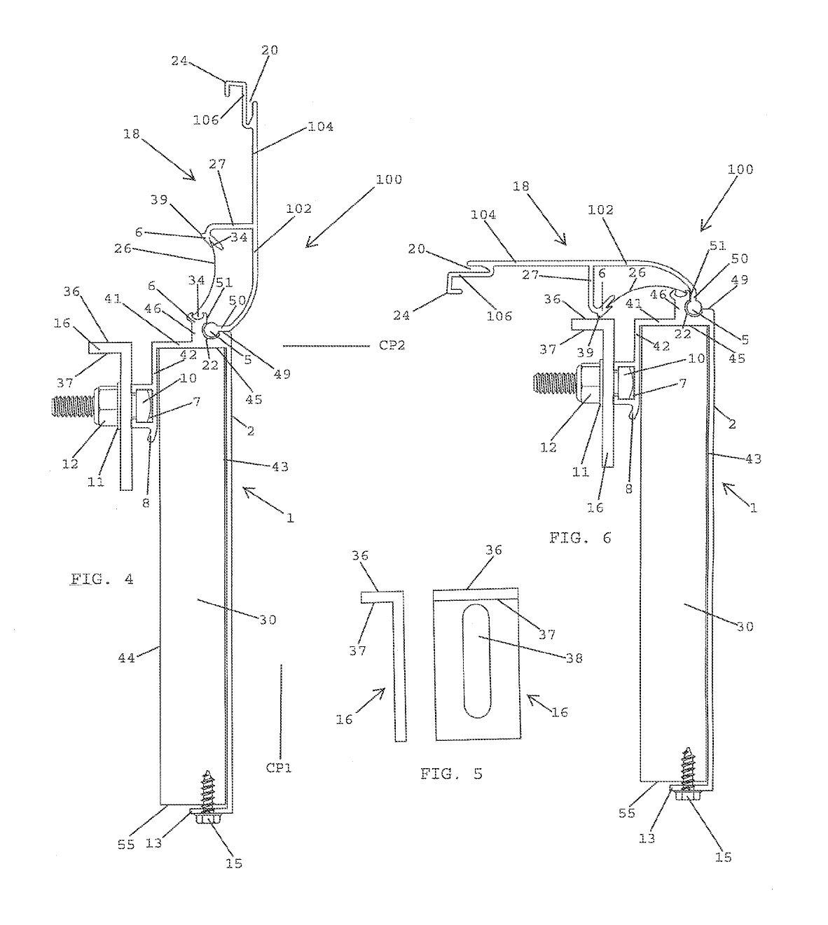

Referring now to FIG. 5, there is illustrated a side view and front view of an example embodiment of L-shaped bracket 16. L-shaped bracket 16 preferably includes a longitudinally elongated aperture such as opening 38, which is configured to allow the height of L-shaped bracket 16 to be adjusted up or down relative to T-track 7 and hanger back 42 of trim base 1. The height of L-shaped bracket 16 preferably sets the closed position angle (relative to second common plane CP2) between trim cap 18 and trim base 1 via rotational pivot about hinge pin 5 and hinge 22.

Referring now to FIG. 6, there is illustrated trim assembly 100 in the closed position with bolt 10 preferably in T-track 7 and nut 12 securing L-shaped bracket 16 to T-track 7 and hanger back 42 of trim base 1. When trim cap 18 is rotated from the open position (FIG. 4) to the closed position (FIG. 6), stop break 51 prevents trim cap 18 from rotating beyond approximately one hundred eighty degrees (180°) relative to second common plane CP2 or such other desired angle determined by the curve of hinge pin extension 102. Preferably, adjustable elevation of bracket 16 may provide additional support in stopping the rotation of trim cap 18 or may stop the rotation before stop leg 50 comes into contact with stop break 51 thereby raising or decreasing the angle (from approximately ninety degrees [90°]) at which trim cap 18 would otherwise stop.

Referring again to FIGS. 4 and 6, there is illustrated a gap between bottom surface 55 of billboard frame 30 and mounting flange 13 to accommodate installation of trim base 1 onto billboard frame 30. Multiple screws 15 may be positioned along the length of trim base 1 to secure trim base 1 to billboard frame 30.

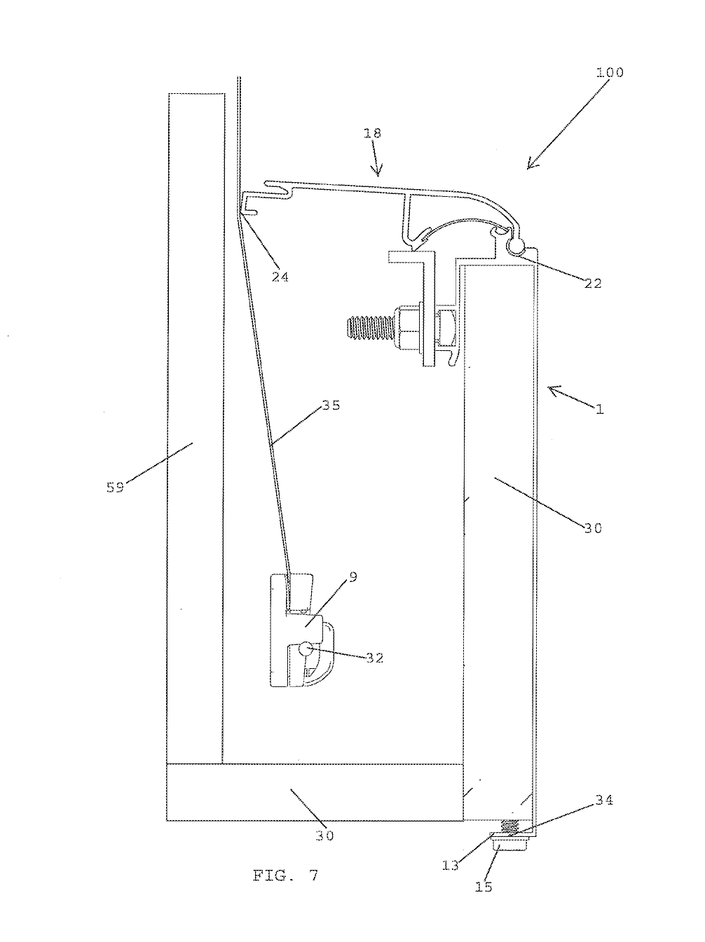

Referring now to FIG. 7, there is illustrated an example embodiment of trim assembly 100 attached to billboard frame 30. A representative billboard is shown that preferably includes billboard frame 30, wood substrate 59, display sheet 35, display sheet locking tension clip 9, and cable 32. Preferably, wood substrate 59 forms the face of the billboard on which display sheet 35 typically rests. With the cable tensioning system, which includes locking tension clip 9 and cable 32, display sheet 35 is stretched and, in some cases, does not rest on wood substrate 59. In use, trim base 1 is preferably hung on wood frame 30 of the billboard. Trim cap 18 is preferably rotated about hinge 22 to its closed position, whereby contact end 24 makes contact with display sheet 35 covering the gap between billboard frame 30 and display sheet 35. In an alternative embodiment, the length of trim cap 18 may be greater than the distance forming the gap between billboard frame 30 and wood substrate 58, and may cause contact end 24 to press display sheet 35 against wood substrate 59.

Referring now to FIG. 8, there is illustrated an example embodiment of trim assembly 100 attached to billboard frame 30. FIG. 8 depicts an alternative embodiment of trim base 1 in which hanger top 41 is extended in second common plane CP2 thereby obviating the need for T-track 7, bracket 16, and the nut, bolt, and washers used to secure bracket 16 to trim base 1. Splice track 60 is an alternative embodiment used to secure one trim base to another abutting trim base with a splice bar inserted in splice track 60. Moreover, another alternative embodiment would delete the arms of splice track 60 leaving hanger back 42 and flange 8 in place. In another alternate embodiment, hinge 22 and hinge pin 5 are shown reversed. In this embodiment, the hinge is preferably formed as a circular tube such as hinge pin 5 that runs the approximate length of trim base 1. Hinge pin 5 may preferably include opening 48 near the top of the circular tube for the purpose of an efficient method of forming a tube in the extrusion process. In this alternate embodiment, mount leg 46 may curve from top section 41 of trim base 1 to form recess 47 and stop 25. Hinge pin 5 is preferably formed as a rotational couple member such as hinge 22 capable of releasably retaining trim cap 18 in rotational pivot about trim base unit 1. Recess 47 preferably enables hinge 22 to rotate about circular tube hinge pin 5, specifically counter-clockwise in the orientation depicted in FIG. 8 from trim cap 18 in an opened position (shown in FIG. 4) to the closed position (shown in FIG. 8). Moreover, recess 47 is preferably configured to act as a stop such as stop 25 to prevent trim cap 18 from opening beyond a desired angle (relative to second common plane CP2), which typically is approximately ninety degrees (90°) from the closed position. Still further, stop 25 of recess 47 formed by curved mount leg 46 acts as a stop to prevent trim cap 18 from opening beyond a preferable angle determined by the combined rotational depth of recess 47 and the length of leading edge 58 of hinge 22. Moreover, leaf spring mount 6 preferably protrudes out of circular tube hinge pin 5 at or near the ten o'clock and eleven o'clock position of circular tube hinge pin 5.

It is contemplated herein that circular tube hinge pin 22 may be configured without opening 48 but would rather be configured as a solid tube that runs the approximate length of trim base 1. In still another embodiment, instead of a tube, hinge pin 5 may be configured as a solid circular bead or rib. One of ordinary skill would recognize that less material is required, and therefore less cost incurred, using a tube with an opening near the top rather than a solid circular bead or rib for hinge pin 5.

Referring now to FIG. 9, there is illustrated trim assembly 100 in the closed position with alternative embodiment disclosing a locking mechanism such as cap lock 29 shown in a locked position as a result of the engagement of locking flange 40 against bracket bottom 37 of bracket 16. Cap lock 29 is preferably affixed to support extension 104 and includes locking flange 40 configured to releasably or rotationally latch with L-shaped bracket 16 of trim base 1 to lock or latch trim cap 18 in a closed position. L-shaped bracket 16 preferably includes bracket top 36 and bracket bottom 37. Bracket top 36 preferably acts as a rotational stop for trim cap 18 when nub 39 of leaf mount extension 27 makes contact with bracket top 36. Moreover, bracket bottom 37 acts as a stop for cap lock 29 when locking flange 40 is preferably rotated to a position beneath bracket bottom 37 latching trim cap 18 to trim base 1 in a closed position.

It is contemplated herein that trim cap 18 may be required to be locked in the closed position to prevent pedestrians from opening the trim cap 18, especially for billboards mounted low to the ground.

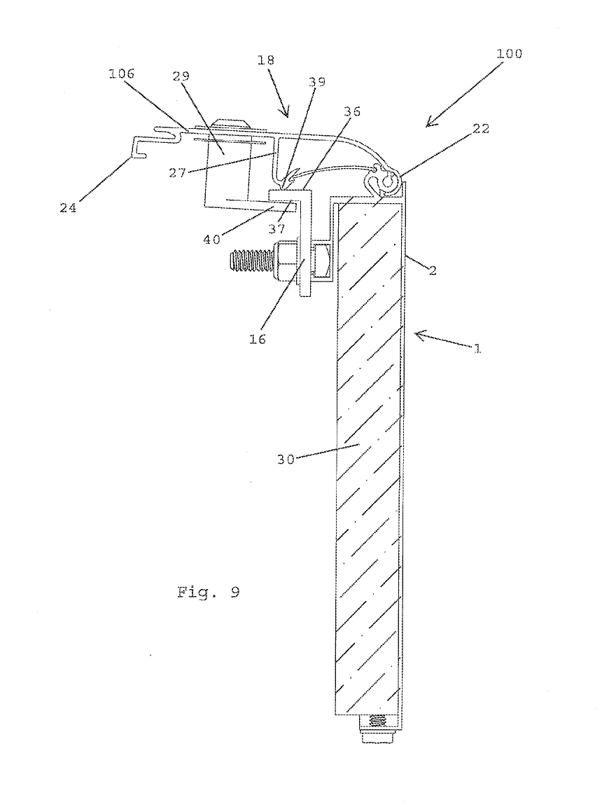

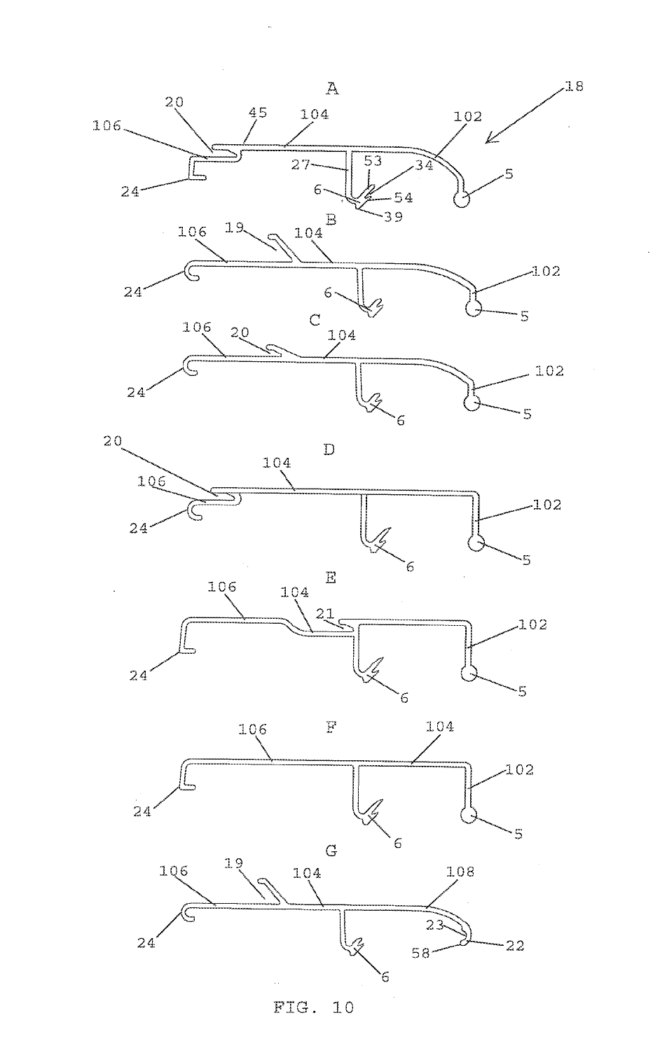

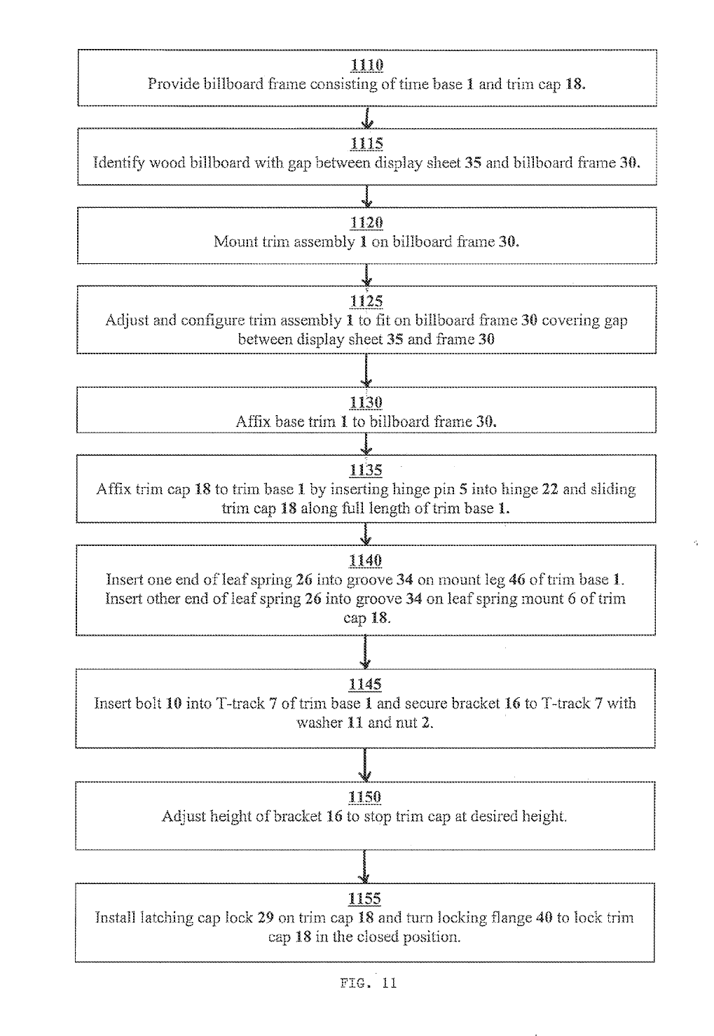

Referring now to FIG. 10, there are illustrated example embodiments of trim cap 18 (A through G). It is contemplated herein that all embodiments of trim cap 18 may contain common characteristics that can vary in size, shape, and position. As depicted in the side views in FIG. 10A-10F, these common characteristics are hinge pin 5, hinge pin extension 102, support extension 104, leaf mount extension 27, leaf mount 6, contact extension 106, and contact end 24. Preferably, leaf mount extension 27 extends downward (from the orientation depicted in FIG. 10) and terminates at leaf spring mount 6. Leaf spring mount 6 preferably includes upper lip 53 and lower lip 54, which form groove 34 into which one end of leaf spring 26 may be inserted. Upper lip 53 is preferably longer in length than lower lip 54 as depicted in FIGS. 10A, and 10D-10F. It is recognized that the longer upper lip 53 extending from the base of leaf mount 6 facilitates the insertion of leaf spring 26 into leaf mount 6. To facilitate rotational opening of trim cap 18 when under tension from leaf spring 26, opening lip 20 may preferably be positioned in a variety of locations along contact extension 106 and may include one or more sizes and configurations to leverage against leaf spring 26. FIG. 10B illustrates opening lip 19, which is large enough for insertion of adult-sized fingers to open trim cap 18. Finger-size openings may be advantageous on billboards not accessible to the general public, such as billboards mounted high above the ground.

On billboards accessible to the general public, a trim cap that can only be opened with a specialized tool or a common tool such as a screw driver may be desirable. FIGS. 10A, 10C, and 10D-E depicts example embodiments of trim cap 18, which may require a specialized opening tool or a screw driver. Preferably, opening lip 20 extends at a narrow angle upward from contact extension 104 in one embodiment depicted in FIG. 10C. The gap or groove formed between contact extension 106 and opening lip 20 may be large enough for insertion of the end of a common screw driver or special tool to provide leverage to open trim cap 18. FIG. 10D depicts opening lip 20 at the end of contact extension 106 similar to the caps depicted in FIG. 2-8. In FIG. 10E support extension 104 preferably includes recessed tool opening lip 21, configured to prevent opening of trim cap 18 with a common screw driver. In this example embodiment trim cap 18 preferably requires a specialized tool with a 90° angled blade for insertion into recessed opening lip 21 to open trim cap 18. FIG. 10F depicts trim cap 18 without any opening lip, which may be desirable on trim housing assemblies in which there is relative weak tension created by leaf spring 26 or where trim assembly 100 is installed on a billboard on which the display sheet is permanent or seldom changed. FIG. 10G depicts trim cap 18 with hinge 22 instead of hinge pin 5 at the first end. This is an example of trim cap 18 with an alternative finger opening lip 19 in the reverse configuration depicted in FIGS. 8 and 9.

It is contemplated herein that sections or integral sections of trim cap 18 may include various configurations and sizes and such sections may be arranged proximate one to another to fill the gap between the display sheet and the billboard frame. Moreover, except for the reverse hinge configuration using hinge cap 18 depicted in FIG. 10G, each embodiment of trim cap 18 preferably includes contact end 24 at one end of trim cap 18 and on the opposite hinge pin 5. Contact end 24 is preferably rounded to prevent cutting or scraping of the display or display sheet when trim cap 18 is in the closed position.

In an example embodiment, the length of trim cap 18 from hinge pin 5 to contact end 24 is approximately twice the length of the gap between the billboard frame 30 and the wood substrate 59. The forty-five degree (45°) angle on the trim cap 18 of trim assembly 100 running along the bottom of the billboard prevents pedestrians from placing bottles, cans, and other unwanted debris within the billboard's trim housing assembly or on trim cap 18. In another example embodiment, the length of trim cap 18 from hinge pin 5 to contact end 24 is preferably equal to or slightly longer than the length of the gap between the billboard frame 30 and the wood substrate 59. When trim cap 18 is closed, it forms approximately a ninety degree (90°) angle (relative to second common plane CP2) or close to it if said length is slightly longer. The slightly longer length of trim cap 18 assures that media contact 24 will press against display sheet 35 creating additional tension on the display sheet and preventing rain water, dirt, and other unwanted substances or materials from entering the billboard's trim housing assembly, cable tensioning system or other media display system.

It is contemplated herein that sections or integral sections of trim base 1 may include various configurations and sizes and such sections may be arranged proximate one another to fit one or more sizes and configurations of billboard frame.

Referring now to FIG. 11, there is illustrated a flow diagram 1100 of a method of filling the gap between a billboard frame and a display sheet by affixing border trim assembly 100 to a billboard frame. In block or step 1110, providing billboard frame, which comprises trim base 1 and trim cap 18 as described above in FIGS. 1-10. In block or step 1115, identifying a billboard with a gap between the display or media sheet and the billboard frame. In block or step 1120, mounting said border trim assembly 100 to the billboard frame 30. In block or step 1125, adjusting and configuring border trim assembly 100 to fit such gap between the display sheet and billboard frame. In block or step 1130, affixing base trim 1 to the billboard frame. In block or step 1135, affixing trim cap 18 to base trim 1. In block or step 1140, inserting leaf spring 26 into leaf mounts 6 to bias trim cap 18 in a closed position to cover such gap. In block or step 1145, inserting bolt 10 into T-track 7 and securing L-shaped bracket 16. In block or step 1150, adjusting the height of L-shaped bracket 16 to stop trim cap at desired height. In block or step 1155, installing latching lock cap 29 and locking trim cap 18 in the closed position.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention having been described in detail, it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A border trim assembly for a billboard frame having a gap between the frame and a display sheet, the assembly comprising:
a trim cover having a front face and a hanger section configured to affix to the billboard frame;
a concave member positioned on said hanger section; and
a trim cap having a support extension and a contact extension configured to rotate about said concave member, wherein said trim cap is configured to cover the gap.

2. The border trim assembly of claim 1, further comprising a spring positioned between said hanger section and said support extension wherein said spring is configured to rotate said trim cap about said concave member.

3. The border trim assembly of claim 1, wherein said base member is configured to fit a plurality of billboard frames.

4. The border trim assembly of claim 1, wherein said hanger section further comprises at least one flange configured to encase the billboard frame.

5. The border trim assembly of claim 1, wherein said hanger section further comprises at least one flange configured to guide said base member over the billboard frame.

6. The border trim assembly of claim 4, wherein said at least one flange further comprises at least one aperture therein configured to receive an attachment mechanism.

7. The border trim assembly of claim 2, wherein said hanger section further comprises a first leg extension configured to elevate said concave member.

8. The border trim assembly of claim 7, wherein said first leg extension of said hanger section further comprises a first spring mount.

9. The border trim assembly of claim 1, wherein said support extension further comprises a pin member configured to releasably rotate within said concave member.

10. The border trim assembly of claim 9, wherein said support extension further comprises a second leg extension configured to extend said pin member to said concave member.

11. The border trim assembly of claim 8, wherein said support extension further comprises a second spring mount.

12. The border trim assembly of claim 11, wherein said spring is positioned between said first spring mount and said second spring mount and configured to rotate said trim cap about said concave member.

13. The border trim assembly of claim 11, wherein said support extension further comprises a third leg extension configured to extend said second spring mount.

14. The border trim assembly of claim 1, wherein said contact extension further comprises a display contact end configured to be in contact with the display sheet.

15. The border trim assembly of claim 14, wherein said contact extension further comprises a handle configured to grip said contact extension to disengage said contact extension from said display sheet.

16. The border trim assembly of claim 1, wherein said contact extension further comprises a cap lock and said hanger section further comprises a latch configured to lock said trim cap to said base member in a closed position.

17. A border trim assembly for a billboard frame having a gap between the frame and a display sheet, the assembly comprising:
a base member having a front face and a hanger section configured to affix to the billboard frame;
a concave member positioned on said hanger section;
a trim cap having a support extension and a contact extension configured to rotate about said concave member, wherein said trim cap is configured to cover the gap; and
a spring positioned between said hanger section and said support extension wherein said spring is configured to rotate said trim cap about said concave member.

18. The border trim assembly of claim 17, wherein said hanger section further comprises at least one flange configured to encase the billboard frame.

19. The border trim assembly of claim 17, wherein said hanger section further comprises a first leg extension configured to elevate said concave member.

20. The border trim assembly of claim 19, wherein said first leg extension of said hanger section further comprises a first spring mount.

21. The border trim assembly of claim 17, wherein said support extension further comprises a pin member configured to releasably rotate within said concave member.

22. The border trim assembly of claim 21, wherein said support extension further comprises a second leg extension configured to extend said pin member to said concave member.

23. The border trim assembly of claim 20, wherein said support extension further comprises a second spring mount.

24. The border trim assembly of claim 23, wherein said spring is positioned between said first spring mount and said second spring mount and configured to rotate said trim cap about said concave member.

25. The border trim assembly of claim 23, wherein said support extension further comprises a third leg extension configured to extend said second spring mount.

26. The border trim assembly of claim 17, wherein said contact extension further comprises a contact end configured to be in contact with the display sheet.

27. The border trim assembly of claim 26, wherein said contact extension further comprises a handle configured to grip said contact extension to disengage said contact extension from the display sheet.

28. The border trim assembly of claim 17, wherein said contact extension further comprises a cap lock and said hanger section further comprises a latch configured to lock said trim cap to said base member in a closed position.

29. A method of filling a gap between a billboard frame and a display sheet comprising the steps of:
providing a border trim assembly, which further comprises a base member having a front face and a hanger section configured to affix to the billboard frame, a concave member positioned on said hanger section, a trim cap having a support extension and a contact extension configured to rotate about said concave member, wherein said trim cap is configured to cover the gap;
mounting said border trim assembly to the billboard frame;
adjusting said border trim assembly to fit the gap between the display sheet and the billboard frame; and
positioning a leaf spring between said hanger section and said support extension wherein said spring is configured to rotate said trim cap about said concave member to cover the gap.
